(19) United States
(12) Patent Application Publication
(10) Pub. No.: US 2012/0084121 A1
(43) Pub. Date: Apr. 5, 2012

(54) SYSTEMS AND METHODS FOR FACILITATING A SALE BETWEEN A CONSUMER AND MOBILE SUPPLIER

(76) Inventor: Brooke Campbell, Austin, TX (US)

(21) Appl. No.: 13/226,239

(22) Filed: Sep. 6, 2011

Related U.S. Application Data
(60) Provisional application No. 61/390,079, filed on Oct. 5, 2010.
(60) Provisional application No. 61/505,852, filed on Jul. 8, 2011.

(51) Int. Cl. G06Q 30/02; G06Q 10/02; G06Q 30/06

(52) U.S. Cl. 705/7.35; 705/26.9; 705/5; 705/14.49

(57) ABSTRACT

A system and method for facilitating a sale between a consumer and a mobile supplier offering one or more transportable goods for sale that includes one or more supplier devices and one or more consumer devices communicatively coupled to at least one of the supplier devices. The supplier devices may be configured to determine and transmit the approximate current location of one or more items offered for sale, as well as information at least partially describing the items. The consumer devices may be configured to receive the information transmitted by the communicatively coupled supplier device. The consumer devices may further be configured to identify one or more desired items from the items offered for sale.

### PRIORITY CLAIM

This patent application claims priority to U.S. Provisional Patent No. 61/390,079 entitled “SYSTEMS AND METHODS FOR FACILITATING A SALE BETWEEN A CONSUMER AND MOBILE SUPPLIER” filed on Oct. 5, 2010 and U.S. Provisional Patent No. 61/505,852 entitled “SYSTEMS AND METHODS FOR FACILITATING A SALE BETWEEN A CONSUMER AND MOBILE SUPPLIER” filed Jul. 8, 2011.

### BACKGROUND OF THE INVENTION

1. Field of the Invention

The present invention relates to the field of sales facilitation. In particular, embodiments relate to systems and methods of facilitating a sale between a buyer and a mobile seller offering one or more transportable items for sale.

2. Description of the Relevant Art

A sale typically includes a consumer contacting a known supplier at a predetermined address. This address is often a tangible or virtual store. Conversely, a sale may also include a supplier contacting a consumer at a predetermined address. This address is often a home or an electronic mailing address. There are, however, many instances where the address, or location, of a potential sales transaction is not predetermined; for example, when the supplier of the goods and/or services is mobile and the items offered for sale are transportable by the mobile supplier. Such instances may include the on-site sale of event tickets, taxi services, or mobile food vendors.

U.S. Patent Application No. 2009/0030810 to Komenda et al. (“Komenda”) discloses a system and method for facilitating a transaction between a buyer and a seller. Komenda describes an invention operating on the principle of a buyer selecting a seller based on at least one desirable characteristic. An order is communicated to the desired seller and the status, or confirmation, of the order is later provided to the buyer.

Additionally, U.S. Pat. No. 5,965,872 to Grdina (Grdina) describes systems and methods for facilitating the sale of commodity-like goods/services. According to the reference, the goods/services may be of a character such that they are not deliverable to the consumer, but require the consumer to physically travel to the seller. An updateable database is provided from which consumers can select sellers based on certain search criteria. The search criteria may include the address of the retailer outlet.

### SUMMARY

Described herein are various embodiments of a system and method for facilitating a sale between a consumer and a mobile supplier. In some embodiments, the system includes one or more supplier devices and one or more consumer devices communicatively coupled to at least one of the supplier devices.

In some embodiments, the supplier devices are configured to transmit information at least partially describing one or more items offered for sale. In one embodiment, the supplier devices are further configured to determine and transmit information at least partially specifying the current location of at least one of the items offered for sale.

In certain embodiments, the consumer devices are configured to receive the information transmitted by a communicatively coupled supplier device. In one embodiment, the consumer devices are further configured to identify one or more desired items from the items offered for sale.

In some embodiments, a method of locating one or more transportable items offered for sale by a mobile supplier includes determining an initial location and identifying one or more desired items from one or more items offered for sale. In certain embodiments, the items offered for sale are portable and the location of at least one of the items coincides with the location of a mobile supplier. In one embodiment, the method further includes receiving information comprising the approximate location of at least one of the desired items and moving from the initial location toward the approximate location of the desired item.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1A is a perspective view of an embodiment of a communication device;

FIG. 1B is a block diagram of the communication device depicted in FIG. 1A;

FIG. 2 illustrates an embodiment of a system for facilitating a sale between a consumer and a mobile supplier offering one or more transportable items for sale;

FIG. 3 illustrates an embodiment of a geographic map indicating at least the approximate location of one or more desired items in relation to the approximate location of a consumer device;

FIG. 4 illustrates an embodiment of a system for facilitating a sale between a consumer and a mobile supplier offering one or more transportable items for sale where the items are located apart from the supplier;

FIG. 5 illustrates an embodiment of a system for facilitating a sale between a consumer and a mobile supplier offering one or more transportable items for sale with a database server;

FIG. 6A is a flowchart depicting a method of locating one or more transportable items offered for sale by a mobile supplier;

FIG. 6B is an additional flowchart depicting a method of locating one or more transportable items offered for sale by a mobile supplier.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Thus, for example, reference to “an item” may include two or more items. Furthermore, the word “may” is used throughout this application in a permissive sense (i.e., having the potential to, being able to), not in a mandatory sense (i.e., must). The term “include,” and derivations thereof, mean “including, but not limited to.” Terms relating to orientation, such as “upper”, “lower”, “top”, “bottom”, “left”, or “right”, are used for reference only; the device herein may be used in any orientation. The order of any method may be changed, and various elements may be added, reordered, combined, omitted, modified, etc.

In the context of this application, the following terms are defined as:

A “supplier” refers to an entity capable of offering one or more items for sale. Examples of a “supplier” include a private seller, manufacturer, wholesaler, merchant, or vendors.

A “consumer” refers to an entity capable of purchasing an item from a supplier.

A “supplier device” refers to a communication device, operated by a supplier, capable of sending and receiving a transmission signal. Examples of a “supplier device” include a personal computer, laptop computer, cellular telephone, mobile networking device, or a vehicular communication device.

A “consumer device” refers to a communication device, operated by a consumer, capable of sending and receiving a transmission signal. Examples of a “consumer device” include a personal computer, laptop computer, cellular telephone, mobile networking device, or a vehicular communication device.

An “item” refers to any commercial good or service. Examples of an “item” include event tickets, food stuffs, electronics, apparel, repair services, or personal services.

A “desired item” refers to an item within the desired specifications or preferences of a consumer.

A “database server” refers to a device or program that provides database services to one or more other devices. A “database server” may include one or more processors and/or memory mediums for executing programs. The programs stored in the memory medium may be executable to perform the functionality of the database server.

A “communication channel” refers to a channel used to convey information from a transmitter to a receiver.

A “mobile supplier” refers to a supplier capable of conducting sales transactions at various locations.

A “memory medium” refers to any of various types of memory devices or storage devices. The term “memory medium” is intended to include an installation medium, a computer system memory or random access memory, or a non-volatile memory. Examples of a “memory medium” include a CD-ROM, floppy disk, DRAM, DDR RAM, SRAM, a hard drive, optical storage, and flash memory. A “memory medium” may include other types of memory as well, and combinations thereof.

A “processor” refers to an electronic device or circuit capable of executing computer programs.

A “computer program” or “program” refers to any type of executable program instructions, code, script, data, or combination thereof that may be stored in a memory medium.

A “communications network” refers to a system including one or more communication channels (i.e., lines, satellite frequency, radio waves, etc.) interconnecting one or more nodes (i.e., servers, routers, computers, communication devices, etc.). Examples of a “communications network” include a cellular telephone network, the internet, a local area network (LAN), or a wide area network (WAN).

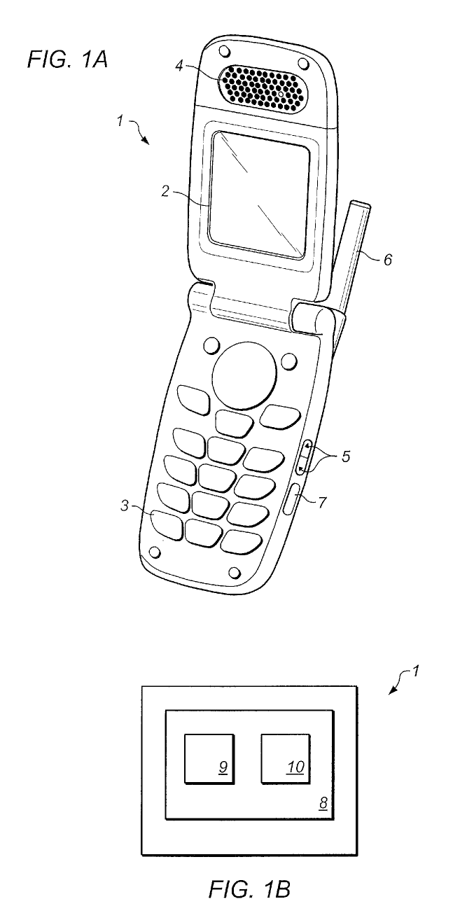

FIG. 1A illustrates an embodiment of a communication device suitable for use as a supplier device or a consumer device. Communication device 1 includes display 2, interface keys 3, speaker 4, volume controls 5, transceiver 6, and power button 7. In some embodiments, transceiver 6 wirelessly transmits and/or receives information via one or more communications networks or communication channels. The elements of communication device 1 described herein are exemplary in nature. That is, the shape, type, and elements of communication device 1 may be altered, removed, and/or added, substituted, etc. without surpassing the scope of the present technique. For example, a communication device may include a touch screen display serving as an interface medium, as opposed to one or more interface keys. Furthermore, a communication device may include additional elements, such as a microphone or keyboard. Any other known peripheral elements are also contemplated.

FIG. 1B is a block diagram illustrating an embodiment of a communication device. Communication device 1 includes processor 8 and memory medium 9 for executing programs. The programs stored in the memory medium may be executable to perform the functionality of either, or both of, a supplier device and consumer device as described herein. Communication device further includes Global Positioning System (GPS) module 10. The functionality of GPS module 10 may be consistent with any type that is well known in the art. For example, GPS module 10 may manage interaction between communication device 1 and one or more GPS satellites in order to determine detailed location information pertaining to the current position of the device. In some embodiments, the GPS module is embedded internally within a communication device. In alternate embodiments, the GPS module is a peripheral element.

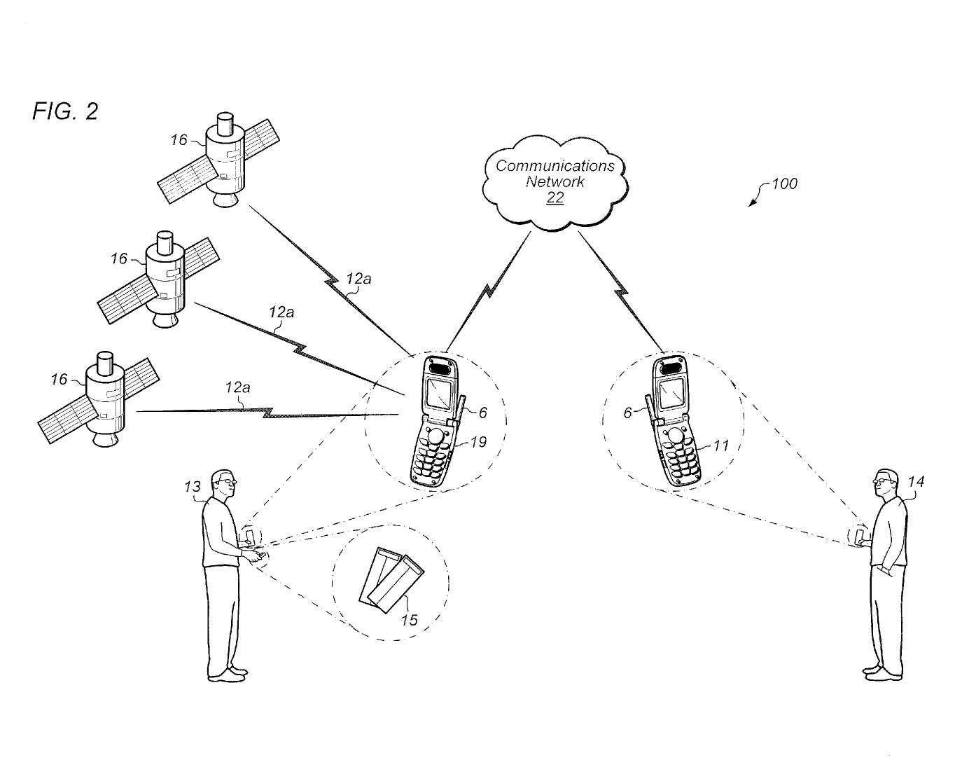

FIG. 2 illustrates an embodiment of a system for facilitating a sale between a consumer and a mobile supplier offering one or more transportable items for sale. System 100 includes supplier device 19 communicatively coupled to consumer device 11 via communications network 22. The coupled devices may communicate with one another. For example, consumer device 11 may be capable of receiving a wireless data transmission from supplier device 19, and vice versa, via transceivers 6. Any known protocol associated with wireless data transmission may be used. Supplier device 19 and consumer device 11 may also be communicatively coupled by way of one or more relaying intermediate servers, routers, and/or other known network devices. Moreover, data transmitted from one device may be manipulated and/or processed before being received by a corresponding, coupled device. According to the depicted embodiment, supplier device 19 is communicatively coupled with one or more GPS satellites 16 via communication channels 12a. In some embodiments, transceiver 6 receives information from GPS satellites 16. In one embodiment consumer device 11 includes an embedded GPS module. According to the embodiment, the GPS module manages interaction with GPS satellites 16 in order to determine detailed location information pertaining to the current position of supplier device 19. Supplier device 19 is operated by supplier 13 and consumer device 11 is operated by consumer 14. Additionally, supplier 13 is in possession of items 15. As such, the location of items 15 may coincide with that of supplier device 19 and supplier 13.

Supplier 13 may elect to offer items 15 for sale. In some embodiments, supplier 13 may vary the location of items 15. In one embodiment, items 15 are portable and may be physically transported by supplier 13, for example by walking and carrying the items. Any other means or method of varying the location of items 15 may also be used. In certain embodiments, supplier device 19 is configured to receive and store information describing items 15 (see FIGS. 1A and 1B). Such information may be provided by supplier 13. For example, a supplier offering event tickets for sale may provide information including a description of the event, a description of the tickets (i.e, where the corresponding seats at the event venue are located, whether or not the seats are grouped, etc.), a description of the event venue, the asking price for the tickets, the number of tickets, etc. Supplier 13 may provide information to supplier device 19 by any means or method of data entry. In some embodiments, supplier device 19 includes one or more components to facilitate data entry, e.g., a keyboard, mouse, touch-screen monitor, microphone, etc. Supplier device 19 may also receive and store information from one or more additional suppliers via wireless communication. Information describing one or more items offered for sale may be any amount of data or knowledge pertaining to the items and/or the proposed transaction. Such information may include, but is not limited to, any combination of the following: price, type, condition, name, intended use, expiration date, supplier contact information, accepted method of payment, etc. In certain embodiments, supplier device 19 is further configured to transmit information describing items 15 through communications network 22. In one embodiment, supplier device 19 is configured to transmit information describing items 15 through communications network 22 automatically, at predetermined intervals.

In some embodiments, supplier device 19 may determine information specifying the approximate current location of items 15. Information specifying the approximate current location of the items may be any amount of pertinent data or knowledge. Such information may include, but is not limited to, any combination of the following: country, city, block, state, geographic coordinates, a web geographic map, or a pictorial geographic map. In the illustrated embodiment (FIG. 2), supplier 13 is in possession of items 15. As such, the location of items 15 coincides with that of supplier 13 and supplier device 19. In certain embodiments, supplier device 19 may determine detailed location information through communication with GPS satellites 16 (using a GPS module), via communication channels 12a. Supplier device 19 may transmit all, or at least a portion, of the location information through communications network 22. Supplier device 19 may also transmit advertising information through communication network 22. In one embodiment, supplier device 19 is configured to determine and/or transmit information automatically, at predetermined intervals.

In some embodiments, consumer device 11 may receive information transmitted through communications network 22 from supplier device 19. Consumer device 11 may also receive information transmitted from one or more other communicatively coupled devices. Consumer device 11 may display any portion of the received information. For example, at least a portion of the received information may be displayed graphically or alphanumerically. In some embodiments, consumer device 11 may identify one or more desired items from items 15 offered for sale. The desired items may be distinguished through information provided by consumer 14. Such information may include one or more preferences of consumer 14. Preferences may include, but are not limited to, any combination of the following: price range, type, condition, name, intended use, expiration date, location, age group, genre interests, etc. For example, a consumer interested in purchasing event tickets might provide preferences including a preferable event venue, area (geographic), artist, sports team, and/or approximate current location. Such information may be referred to herein as “item preference information.” In some embodiments, consumer device 11 receives and stores item preference information provided by consumer 14. Consumer 14 may provide item preference information to consumer device 11 by any means or method of data entry. Consumer device 11 may include one or more elements to facilitate data entry, e.g., a keyboard, mouse, touch-screen monitor, microphone, etc. In one embodiment, the stored item preference information is organized in the form of a user profile. In one embodiment, consumer 14 may update/modify the user profile. In some embodiments, the item preference information provided by consumer 14 is sufficient to identify one or more desired items from items 15 offered for sale. In certain embodiments, consumer device 11 is configured to identify one or more desired items from one or more items offered for sale by comparing the information received from supplier device 19 with the item preference information provided by consumer 14 (see FIG. 1B). Any known method of data comparison may be used, such as those known in the field of computational statistics and data analysis. In one embodiment, consumer device 11 may further determine one or more desired items automatically at predetermined intervals.

In some embodiments, consumer device 11 may determine one or more desired items by posing a structured query to an external database server. Consumer device 11 may also pose a structured query to an internal database. In certain embodiment, the structured query includes at least a portion of the item preference information provided by consumer 14. In some embodiments, consumer device 11 may apply a filter command to a set of data. A filter command is a rule used to determine the data that should remain visible to the user. That is, a filter command may narrow the scope of the items offered for sale that are presented to a consumer. A filter command may be applied with one, or several, criterion. For example, a consumer interested in purchasing event tickets may only be able to attend the event within a specific range of dates. Applying a filter command with a date range criterion may ensure that only event tickets representing events in the prescribed date range are shown to the consumer. In one embodiment, a filter command is included in the structured query. The consumer device may also include a GPS module. The GPS module may determine detailed location information specifying the approximate current location of the device via GPS satellites. In one embodiment, the location information is included in the structured query.

In some embodiments, consumer device 11 may direct consumer 14 from a current location to the approximate location of one or more desired items. In one embodiment, the directions are verbal, however, directions may also be presented in any known fashion, including graphically or alphanumerically. In certain embodiments, the directions are provided regularly at predetermined intervals. In certain embodiments, the directions are provided intermittently. In one embodiment, the directions are provided “turn-by-turn”.

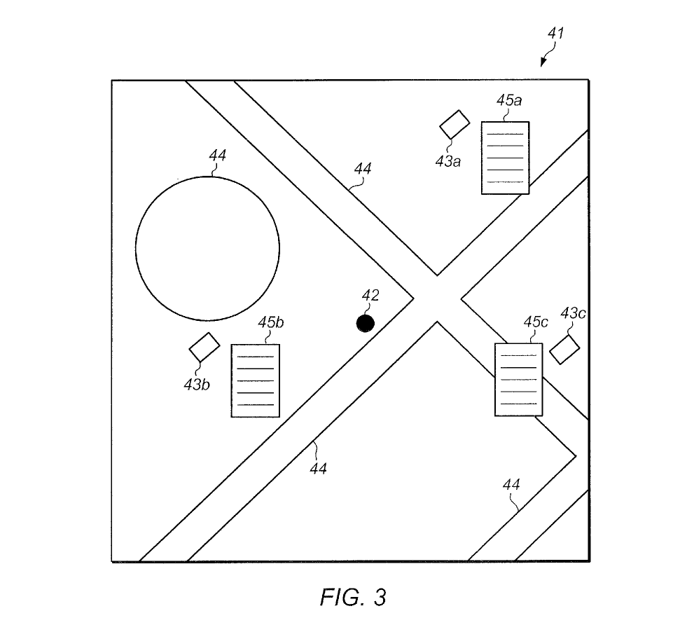

In some embodiments, consumer device 11 may provide a geographic map indicating at least the approximate location of one or more desired items in relation to the approximate location of the consumer device. FIG. 3 depicts an embodiment of such a geographic map. Geographic map 41 may be suitable for directing consumer 14 from a current location to the approximate location of one or more desired items. Geographic map 41 may be provided on the display of consumer device 11. Geographic map 41 may include graphical representation 42 of consumer device 11, one or more graphical representations 43 (depicted as 43a, 43b, and 43c in FIG. 3) of the desired items, and graphical representations 44 of one or more geographic landmarks (e.g., a stadium, street, park, etc.). A graphical representation may appear as any distinguishable shape or feature displayed on geographic map 41 (e.g., a symbol, shape, and/or legible text). In some embodiments, graphical representation 42 of consumer device 11 may provide a point of reference for one or more other graphical representations. For example, in the illustrated embodiment, graphical representation 42 of consumer device 11 may be located proximate the center of geographic map 41 during use. In some embodiments, the relationship of graphical representations 42, 43, and 44 as depicted on geographic map 41 is at least approximately proportional the physical geographic relationship between consumer device 11, the desired items, and the landmarks respectively. In some embodiments, one or more graphical representations 43 of the desired items may be substantially identical. In some embodiments, one or more of graphical representations 43 may be significantly dissimilar. For example, the graphical representation of a more desirable item may be displayed as a different color or shape in comparison to the graphical representation of a less desirable item. In some embodiments, one or more graphical representations 43 of the desired items may include information at least partially describing the desired items. For example, information at least partially describing one or more desired event tickets may include a description of the event, a description of the tickets (i.e., where the corresponding seats at the event venue are located, whether or not the seats are grouped, etc.), a description of the event venue, the asking price for the tickets, the number of tickets, etc. In certain embodiments, information at least partially describing the desired items is displayed as legible text 45 (depicted as 45a, 45b, and 45c in FIG. 3) located proximate graphical representations 43 of the desired items on geographic map 41. In some embodiments, the graphical representations displayed on geographic map 41 are updated regularly at predetermined intervals or intermittently to reflect the last known geographic relationship between consumer device 11, the desired items, and the landmarks respectively.

In some embodiments, consumer device 11 is configured to receive and transmit feedback information through communications network 22 to one or more communicatively coupled devices (e.g., consumer and supplier devices). Feedback information may include any positive, negative, or neutral data describing one or more suppliers or purchased items. Such information may be provided by consumer 14. For example, having purchased one or more event tickets, a consumer may provide information describing the event and/or the transaction process with the supplier.

In some embodiments, supplier device 19 receives information transmitted from consumer device 11. This information may include, but is not limited to, the approximate current location of consumer 14 and/or feedback information.

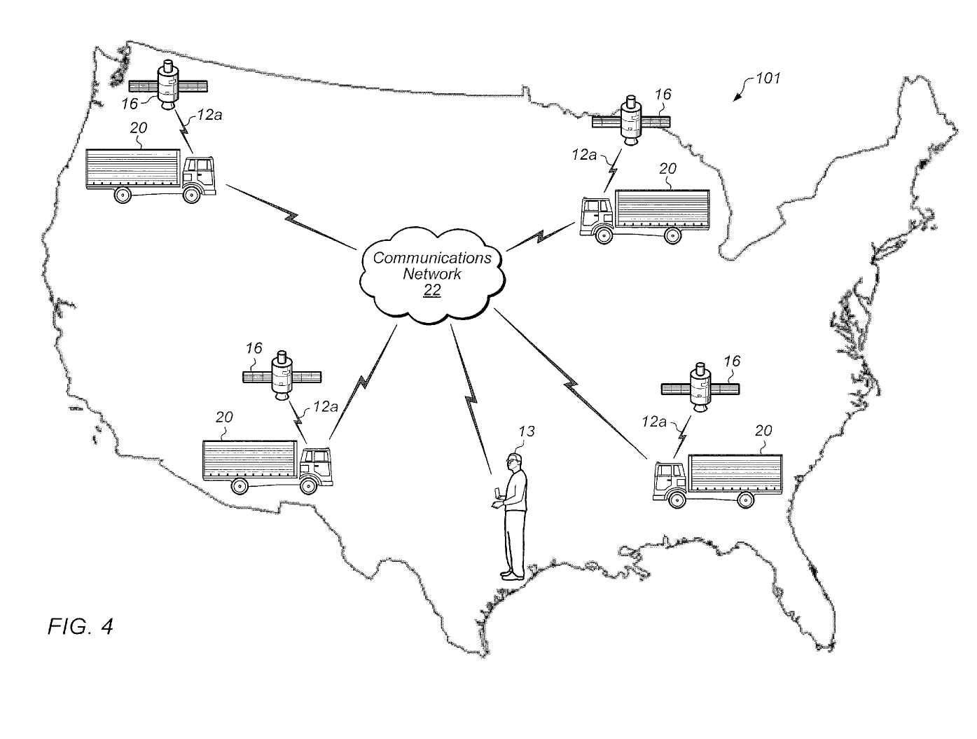

In some embodiments, items offered for sale may be located apart from a supplier. For example, FIG. 4 illustrates an embodiment where system 101 includes one or more items offered for sale in transit aboard motor vehicles 20. Detailed location information may be determined through communication with satellites 16 via communication channels 12a. In some embodiments, motor vehicles 20 are equipped with at least one communication device. In one embodiment, each communication device includes an embedded GPS module and transceiver such that each of the communication devices is communicatively coupled to at least one GPS satellite 16 and at least one supplier device 19 via communication channels 12a and communications network 22 respectively. In some embodiments, one or more of the items offered for sale, onboard motor vehicles 20, is equipped with an embedded GPS module. In some embodiments, supplier device 19 may activate and communicate with the embedded GPS modules such that the modules can determine the approximate location of the items and transmit all, or at least a portion, of the information to the supplier device via communications network 22.

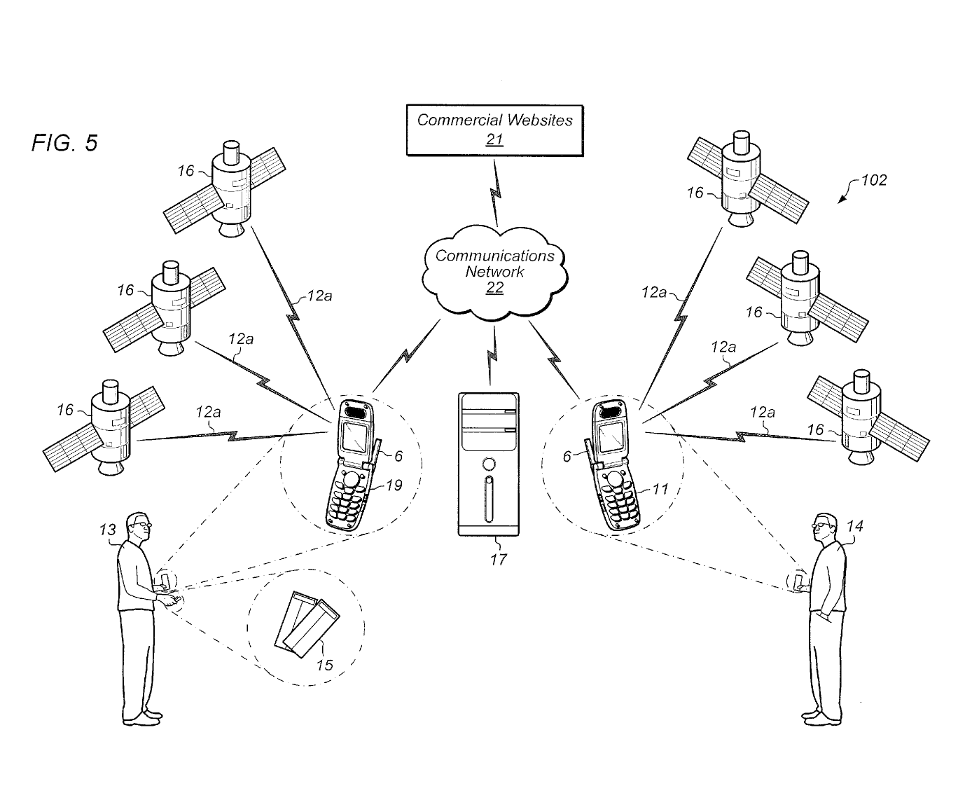

FIG. 5 illustrates a system for facilitating a sale between a consumer and a mobile supplier offering one or more transportable items for sale including database server 17. According to the embodiment shown in FIG. 5, system 102 includes database server 17 communicatively coupled to supplier device 19 via communications network 22. Database server 17 is communicatively coupled to consumer device 11 via communications network 22 as well. Additionally, database server 17 is communicatively coupled to commercial websites 21, via communications network 22. Database server 17 may also be communicatively coupled to one or more additional devices. For example, the system may include a network of consumer and supplier devices coupled communicatively through database server 17 in conjunction with communications network 22.

Database server 17 may transmit and receive information (e.g., item preference information, feedback information, location information, etc.) to and from supplier device 19, consumer device 11, and commercial websites 21 through communications network 22. Database server 17 may also transmit and receive information from one or more additional devices through one or more communications networks. In one embodiment, database server 17 may also store and organize any received information. In one embodiment, database server 17 may aggregate received information over time from multiple communication devices. In one embodiment, database server 17 may provide specific information upon request.

In some embodiments, consumer device 11 may pose a structured query to database server 17. The structured query may be sufficient to identify one or more desired items from one or more items offered for sale. In one embodiment, the structured query includes a filter command. In certain embodiments, database server 17 receives, processes, and subsequently transmits an answer to the query. The query answer may be transmitted to consumer device 19 via communications network 22. In some embodiments, the query answer includes information at least partially describing one or more desired items. In one embodiment, a filter command is applied by consumer device 11 to the data included in the query answer.

In some embodiments, consumer device 11 monitors commercial websites 21 through database server 17. For example, consumer device 11 may transmit a continuous signal to database server 17 requesting information from commercial websites 21. Consumer device 11 may also transmit a signal at predetermined intervals to database server 17 requesting information from commercial websites 21. In one embodiment, consumer device 11 notifies consumer 14 of predetermined activities on commercial websites 21. For example, database server 17 may transmit a notification to consumer device 11 when specific event tickets are offered for sale by one or more of commercial websites 21. Consumer device 11 may then notify consumer 14 of the online activity. For example, consumer device may provide a physical notification i.e., vibrating, as well as an audible and/or graphical notification. The notification may further manifest as a test message, phone call, or electronic message.

In some embodiments, a system analyzes market data to determine product pricing. In one embodiment, an optimal price for an item is determined based on a competitive sales environment among sellers using the system.

In some embodiments, a system provides some or all of the sellers using the system with access to pricing and/or sales information relating to competing products or services sold or offered for sale (by other sellers using the system, sellers not using the system, or both). For example, a seller offering a pair of tickets to an event may be able to view information about competing sales or competing offers. The seller may view, for example, a map that displays the location of tickets being sold by other sellers in the same section of a concert hall, along with the prices and other information for such tickets. The seller can use the information about other offers or other sales to make decisions about the seller's own offering. For example, if there is an abundance of tickets that are not selling in the area where the seller's tickets are located, the seller may reduce the price of the seller's tickets to spur interest in the seller's tickets. Use of a system by competing sellers may drive down ticket prices in real time, as, for example, sellers see the prices of other tickets falling in response to buyer pressure.

In certain embodiments, a system provides some or all of the buyers using a system with access to pricing and/or sales information relating to other buyers on the system. The buyer may view, for example, a map that displays the price other buyers paid for tickets sold to an event in a recent time period (such as the price paid for end-zone seats to a football game in the preceding 30 minutes). The buyer can use the information about offers or sales to other buyers to make changes to the buyer's own purchase criteria (for example, increasing or decreasing the maximum price the buyer will pay for seats).

In some embodiments, a system automatically makes changes to the terms of the offers of one or more sellers or buyers. For example, based on a particular seller's pre-selected settings, the system may automatically reduce the seller's price based on pre-established criteria (such as the average price of similar tickets, or the amount of time remaining before the event starts).

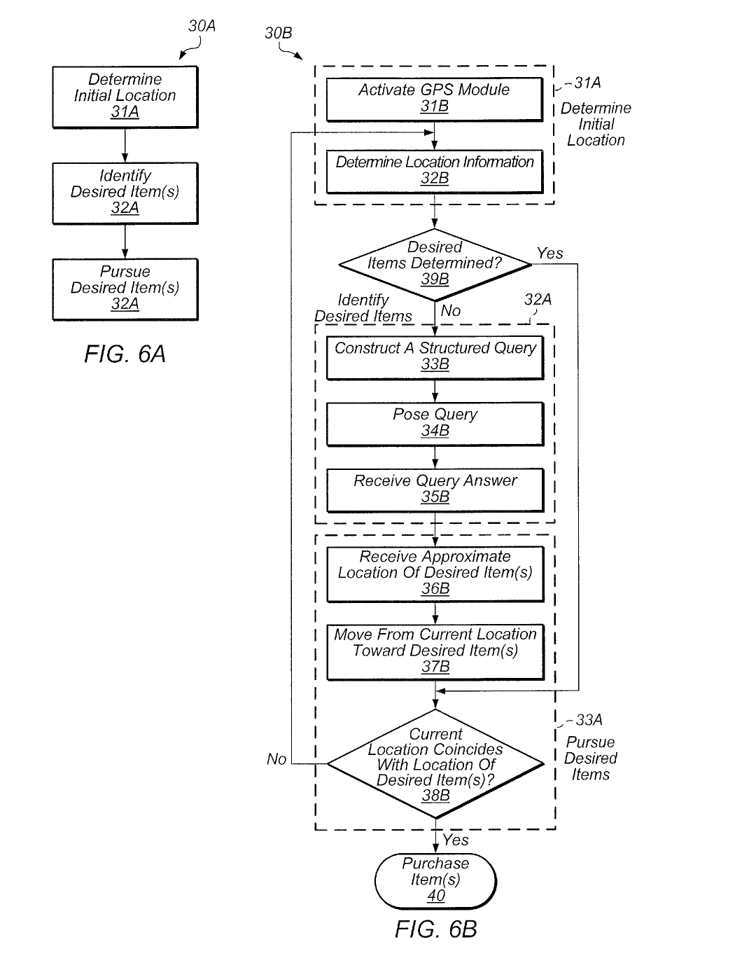

FIG. 6A is a flowchart illustrating a method of locating one or more transportable items offered for sale by a mobile supplier. Method 30A generally includes determining an initial location, identifying one or more desired items from one or more items offered for sale, and pursuing at least one desired item (blocks 31A-33A). In some embodiments, the items offered for sale are portable. In certain embodiments, the location of at least one item offered for sale coincides with the location of a mobile supplier. In one embodiment, the mobile supplier may vary the location of at least one of the items offered for sale.

FIG. 6B is a flowchart illustrating another method of locating one or more transportable items offered for sale by a mobile supplier. In some embodiments, an initial location may be the approximate current location of a consumer any time prior to the identification of a desired item. Determining a current location may include receiving signals from one or more GPS satellites via a GPS module embedded within a consumer device. For example, method 30B includes activating a GPS module as depicted at block 31B, and determining detailed location information as depicted at block 32B. In some embodiments, a GPS module may be activated by the press of a button. A GPS module may also be voice-activated.

In some embodiments, a user of a supplier device or a consumer device can select a particular location as the location of that device, or of one or more devices coupled to the device. For example, a seller of items at or near a venue may select the venue, or a location close to the venue, as the location of supplier device or items offered for sale by the supplier. As another example, a seller of items at or near a venue may select the venue, or a location close to the venue, as the location of one or more consumer devices communicatively coupled to the supplier device. As still another example, a consumer seeking to purchase items at a venue may set the venue as the location for the consumer. In each of the examples above, the items may appear on maps with a GPS locator on top of the venue.

Identifying one or more desired items from one or more items offered for sale may include querying a database using a consumer device. For example, method 30B includes constructing a structured query as depicted at block 33B. In some embodiments, the query criteria are defined as the item preferences of a consumer. In certain embodiments, a consumer may enter and store item preferences on a consumer device. In further embodiments, the item preferences provided by the consumer are sufficient to identify at least one desired item from a plurality of items offered for sale. Method 30B further includes posing the constructed query as depicted at block 34B. In some embodiments, the query is posed to a database server from a communicatively coupled consumer device. In some embodiments, the query is posed to a database server embedded internally within a consumer device. Method 30B also includes receiving an answer to the query as depicted at block 35B. In some embodiments, the query answer may include information at least partially describing one or more desired items. In certain embodiments, the query answer is provided via wireless transmission by an external database server communicatively coupled to a consumer device.

Pursuing at least one desired item may include receiving the approximate location of a desired item, as depicted at block 36B. In some embodiments, the location of the desired item may change over time. For example, a consumer device may receive a transmission originating from the supplier device of a mobile supplier transporting the desired item. In some embodiments, the transmission may include the approximate location of the desired item. In certain embodiments, the approximate location of the desired item is displayed graphically to a consumer on the consumer device. In one embodiment, such information is relayed by a database server. The display may be updated continuously or from time to time to reflect movement of the desired item from one location to another. Method 30B also includes moving from the initial location toward the approximate location of the desired item, as depicted at block 37B.

In some embodiments, pursuing a desired item may include one or more iterative steps. For example, at predetermined time intervals, an intermediate location may be determined via a consumer device. In some embodiments, the intermediate location is the approximate current location of a consumer any time after the identification of a desired item. If it is determined that the intermediate location does not substantially coincide with the location of the desired item (blocks 38B and 39B), an update of the desired item's approximate location may be received (36B). The iteration may proceed until the intermediate location and the location of the desired item substantially coincide or the item is purchased (block 40B).

In some embodiments, the consumer may use the purchased transportable items at the location of the sales transaction. In certain embodiments, a consumer may, during the same trip as that to purchase the items, move to a location near the location of the sales transaction to use the items. For example a consumer may buy event tickets a block away from a concert venue, then go directly to the concert venue to redeem the tickets in exchange for entrance to the concert.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system for locating one or more transportable items offered for sale by a mobile supplier, comprising:
one or more supplier devices configured to transmit information at least partially describing one or more items offered for sale;
wherein the supplier devices are further configured to determine and transmit information at least partially specifying the current location of at least one of the items offered for sale; and
one or more consumer devices communicatively coupled to at least one of the supplier devices and configured to receive the information transmitted by a communicatively coupled supplier device;
wherein at least one of the consumer devices is further configured to:
identify one or more desired items from the items offered for sale; and
graphically display, on a display of the consumer device, a map comprising one or more graphical representations, wherein at least one of the displayed graphical representations shows one or more attributes of at least one of the items offered for sale.

2. The system of claim 1, wherein at least one of the displayed graphical representations shows a seat location in a venue for one or more tickets offered for sale for an event.

3. The system of claim 1, wherein the at least one consumer device is configured to display on the map graphical representations showing attributes of items offered for sale by two or more different suppliers simultaneously.

4. The system of claim 1, wherein the at least one consumer device is configured to display on the map graphical representations showing simultaneously a physical location of two or more different supplier devices.

5. The system of claim 1, wherein the at least one consumer device is configured to display on the map graphical representations showing simultaneously the location of two or more different supplier devices.

6. The system of claim 5, wherein the at least one consumer device is configured to display on the map graphical representations showing simultaneously the location of the consumer device relative to at least two of the supplier devices.

7-8. (canceled)

9. The system of claim 1, wherein the location of at least one of the items offered for sale is variable by a supplier operating the communicatively coupled supplier device.

10-12. (canceled)

13. The system of claim 1, wherein the items offered for sale are event tickets.

14-15. (canceled)

16. The system of claim 1, wherein the consumer devices are further configured to receive and store information provided by a user, wherein the consumer devices are further configured to identify the desired items by posing a query comprising at least a portion of the information provided by the user.

17. The system of claim 16, wherein the consumer devices are further configured to pose the query automatically at predetermined intervals.

18-19. (canceled)

20. The system of claim 1, wherein the communicatively coupled supplier device is further configured to receive information at least partially specifying the current location of the consumer devices.

21. The system of claim 1, wherein the communicatively coupled supplier device is further configured to determine and transmit information at least partially specifying the current location of at least one of the items offered for sale automatically at predetermined intervals.

22-23. (canceled)

24. The system of claim 1, wherein at least one of the consumer devices are further configured to direct a user from a current location to the at least partially specified location one or more desired items.

25. (canceled)

26. The system of claim 1, wherein at least one communicatively coupled supplier device is further configured to transmit advertising information.

27-30. (canceled)

31. A method of locating one or more transportable items offered for sale, comprising:
determining an initial location;
displaying, on a display of a portable consumer device, a map comprising graphical representations simultaneously showing attributes of two or more items offered for sale by two or more mobile suppliers;
identifying one or more desired items from the one or more items offered for sale by the mobile suppliers,
wherein the one or more items offered for sale are portable and the location of at least one of the items offered for sale coincides with the approximate location of at least one of the mobile suppliers;
receiving information comprising the approximate location of at least one of the desired items; and
moving from the initial location toward the approximate location of at least one of the desired items.

32. The method of claim 31, further comprising:
determining an intermediate location;
receiving an update of the information comprising the approximate location of at least one of the desired items; and
moving from the intermediate location toward the updated approximate location of at least one of the desired items.

33-46. (canceled)

47. The system of claim 1,
wherein at least one of the supplier devices is configurable to track a location of the at least one consumer device,
wherein the at least one supplier device is configurable by a user to use a venue location, or a location close to the venue, as the location of at least one of: the supplier associated with the at least one supplier device, or the consumer associated with the at least one consumer device.

48. The system of claim 1
wherein at least one of the consumer devices is configurable to track a location of the at least one supplier device,
wherein the at least one consumer device is configurable by a user to use a venue location, or a location close to the venue, as the location of at least one of: the supplier associated with the at least one supplier device, or the consumer associated with the at least one consumer device.

49. A system for locating one or more transportable items offered for sale by a mobile supplier, comprising:
one or more supplier devices configured to transmit information at least partially describing one or more items offered for sale;
wherein the supplier devices are further configured to determine and transmit information at least partially specifying the current location of at least one of the items offered for sale; and
one or more consumer devices communicatively coupled to at least one of the supplier devices and configured to receive the information transmitted by a communicatively coupled supplier device;
wherein at least one of the supplier devices is further configured to display information to a supplier user about competing sales or offers for sale by one or more other suppliers, or at least one of the consumer devices is configured to provide information to a consumer user about sales to, or offers by, one or more other consumers.

50. (canceled)

51. The system of claim 49, wherein the system is configured to automatically adjust a price of one or more items offered for sale by one supplier in response to a sale or offer for sale by one or more competing suppliers.

52. The system of claim 49, wherein the system is configured analyze market data relating to at least one of the items offered for sale, wherein the system is configurable to adjust the price of the at least one item based at least in part on the market data.
